(19) United States
(12) Patent Application Publication
(10) Pub. No.: US 2012/0225977 A1
(43) Pub. Date: Sep. 6, 2012

(54) MELT PROCESSABLE REACTIVE PELLETS CAPABLE OF FORMING ESTER CONDENSATES AND PROCESS FOR FORMING MELT PROCESSABLE REACTIVE PELLETS

(76) Inventors: Isao Noda, Fairfield, OH (US); William Maxwell Allen, JR., Liberty Twp, OH (US); James Terry Knapmeyer, Rossmoyne, OH (US); Michael Matthew Satkowski, Oxford, OH (US)

(21) Appl. No.: 13/468,764

(22) Filed: May 10, 2012

Related U.S. Application Data
(63) Continuation of application No. 11/961,244, filed on Dec. 20, 2007, now abandoned.
(60) Provisional application No. 60/901,486, filed on Feb. 15, 2007.

(51) Int. Cl. C08L 67/02; C08K 3/34; B29B 9/06; C08L 97/02; C08L 21/00; C08L 67/06; C08L 83/00; C08L 3/02

(52) U.S. Cl. 524/14; 524/604; 524/588; 524/451; 524/445; 524/47; 524/448; 524/513; 264/143

(57) ABSTRACT

Reactive compositions are formed into melt processable reactive pellets. The reactive compositions include at least one filler such as talc, clay, pulp, etc. and a reactive mixture comprising at least one polyhydric alcohol and a reactant selected from the group consisting of at least one organic polyacid; at least one organic anhydride; and combinations thereof. Alternatively, the reactive compositions comprise at least one filler and a prepolymer formed from the reactive mixture.

### CROSS REFERENCE TO RELATED APPLICATION

This application is a continuation of prior U.S. application Ser. No. 11/961,244 filed on Dec. 20, 2007; which claims the benefit of provisional Application No. 60/901,486, filed Feb. 15, 2007.

### FIELD OF THE INVENTION

The present invention is directed to a reactive composition comprising either a monomer mixture or reactive prepolymer capable of making crosslinked thermoset resins, particularly alkyd resins, and solid fillers, such as clay particles, formulated to be melt processable. In a specific embodiment, the reactive composition is made into the form of solid pellets which are capable of being fed into melt processing equipment.

### BACKGROUND OF THE INVENTION

A large number of moldable articles are made from synthetic materials comprising thermoplastic or thermoset resins. Thermoplastic and thermoset resins are typically derived from petroleum based feedstock. The rising cost of petroleum has prompted the need for alternative robust, low cost materials for producing synthetic materials and corresponding articles manufactured therefrom.

Alkyd is a term applied to a group of synthetic thermoset resins best described as polyester condensate resins. This group of material comprises ester condensates of polyhydric alcohols and organic polyacids. Glycerin is the predominant polyhydric alcohol component used in ester condensates. An increasing supply of glycerin has prompted the opportunity for developing a process for forming articles from non petroleum based materials such as alkyd resins.

Conventional plastics are composed of thermoplastic resins such as polyolefins, polypropylene, polyester, etc. Upon heating, thermoplastics become a processable, soft, viscous melt which solidifies or hardens by cooling. After solidification, materials made from thermoplastic resins are not temperature stable and may once again be made molten. They may also creep or plastically deform. Thermoplastic resins can be formed into granular pellets which can be easily fed by themselves or with other additives to an extruder or other process equipment to be melted and processed to fabricate various final products. Thus, the successful preparation of resin pellets often is an important first step of the development of any useful thermoplastic materials.

Thermoset resins such as alkyd resins start as liquid monomer or prepolymer mixtures which must be cured by crosslinking chemical reaction. Epoxy resins and phenol formaldehyde resins are other typical examples of thermoset resins. Unlike thermoplastics, once cured, thermoset resins are temperature stable and do not creep or plastically deform. As a result, most thermoset resins are not melt processable, and therefore, are not capable of being formed into pellets which can later be melt processed in a manner similar to conventional thermoplastics. Instead, articles made from thermoset resins are formed from liquid oligomers or so called prepolymers poured into a mold where the crosslinking reaction is completed.

Although alkyd monomers and prepolymers can become reasonably fluid upon heating, they are viscous and sticky at room temperature making them difficult to handle. Also, unlike most thermoset resins, articles made from alkyd resins are capable of being reprocessed to a prepolymer state and formed into new articles; however, such reprocessing requires additional processing steps, energy and cost. Therefore, producing articles from alkyd resins that are typically made from thermoplastic resins could not be performed on the same equipment used in processing thermoplastics. Thus, the need exist for a means of converting alkyd monomers or prepolymers to solid pellets which can be handled with conventional melt processing equipment widely used for thermoplastic resins.

### SUMMARY OF THE INVENTION

The present invention provides reactive compositions formed into melt processable reactive pellets. The reactive compositions comprise a filler and a reactive mixture capable of making alkyd thermoset resins. The filler can include talc, clay, pulp, TiO₂, thermoplastic starch, raw starch, wood flour, diatomaceous earth, carbon black, silica, inorganic glass, inorganic salts, pulverized plasticizer, pulverized rubber and combinations thereof. The reactive mixture includes a monomer mixture comprising at least one polyhydric alcohol and a reactant selected from the group consisting of at least one organic polyacid; at least one organic anhydride; and combinations thereof. Alternatively, the reactive mixture comprises a prepolymer formed from the monomer mixture; a combination of the prepolymer and the monomer mixture; or a combination of the prepolymer and reactants such as polyhydric alcohol, organic polyacid, organic anhydride, and combinations thereof.

The invention is also directed to a process for making melt processable reactive pellets by combining the aforementioned reactive mixtures and fillers to form a homogeneous mixture. The homogeneous mixture is extruded into strands and cut into pellets.

The invention is further directed to articles such as molded objects, sheets, films, fibers, foams and combinations thereof made from the melt processable reactive pellets.

### DETAILED DESCRIPTION OF THE INVENTION

All percentages, ratios and proportions used herein are by weight percent of the reactive mixture, unless otherwise specified. All average values are calculated “by weight” of the reactive mixture or components thereof, unless otherwise expressly indicated. “Average molecular weight,” or “molecular weight” for polymers, unless otherwise indicated, refers to weight average molecular weight. Weight average molecular weight, unless otherwise specified, is determined by gel permeation chromatography.

“Copolymer” as used herein is meant to encompass copolymers, terpolymers, and other multiple-monomer polymers.

“Reactant” as used herein refers to a chemical substance that is present at the start of a chemical reaction and reacts with one or more other substances or catalysts in or exposed as part of a chemical reaction.

“Mixture” as used herein refers to a mixture of two or more of any of a defined group of components, unless otherwise specified. Lists of alternative ingredients include mixtures of such ingredients unless otherwise specified.

“Biodegradable” as used herein refers to the ability of a compound to ultimately be degraded completely into CH₄, CO₂ and water or biomass by microorganisms and/or natural environmental factors.

“Compostable” as used herein refers to a material that meets the following three requirements: (1) the material is capable of being processed in a composting facility for solid waste; (2) if so processed, the material will end up in the final compost; and (3) if the compost is used in the soil, the material will ultimately biodegrade in the soil.

“Comprising” as used herein means that various components, ingredients or steps can be conjointly employed in practicing the present invention. Accordingly, the term “comprising” encompasses the more restrictive terms “consisting essentially of” and “consisting of”. The present reactive compositions can comprise, consist essentially of, or consist of any of the required and optional elements disclosed herein.

Markush language as used herein encompasses combinations of the individual Markush group members, unless otherwise indicated.

Regarding all numerical ranges disclosed herein, it should be understood that every maximum numerical limitation given throughout this specification includes every lower numerical limitation, as if such lower numerical limitations were expressly written herein. In addition, every minimum numerical limitation given throughout this specification will include every higher numerical limitation, as if such higher numerical limitations were expressly written herein. Further, every numerical range given throughout this specification will include every narrower numerical range that falls within such broader numerical range and will also encompass each individual number within the numerical range, as if such narrower numerical ranges and individual numbers were all expressly written herein.

The present reactive compositions, processes and articles employ composites comprising particulate fillers and a reactive mixture capable of making crosslinked thermoset resins, particularly alkyd resins, from an ester condensation reaction. The reactive mixture comprises a monomer mixture including polyhydric alcohol and a polyfunctional organic polyacid or anhydride. The reactive mixture can also include a prepolymer made by reacting the monomer mixture to a precros slinking stage, or a combination of the prepolymer and the monomer. The reactive mixture is mixed with fillers forming a reactive composition. The reactive composition is made into small reactive pellets which are capable of storage and free flowing in granular form without conglomerating. The reactive pellets can be readily fed into conventional melt processing equipment similar to those commonly used in the plastics industry for processing thermoplastics. During melt processing, the reactive pellets are heated to an elevated temperature sufficient to induce an ester condensation reaction of the reactive mixture which polymerize and crosslink the mixture by liberating water as a reaction byproduct to open atmosphere.

The materials used in forming the aforementioned reactive pellets, methods of making the same and articles formed from melt processing the reactive pellets are further discussed below.

### Polyhydric Alcohol

The reactive mixture used in forming the reactive pellets includes polyhydric alcohol. “Polyhydric alcohol” as used herein refers to an alcohol having two or more alcohol (i.e., hydroxyl) functional groups. Any suitable polyhydric alcohol or combination of polyhydric alcohols is of use; however, monomers, oligomers, or short chain polymer polyhydric alcohols having a molecular weight of less than 2000 g/mol are preferred. Non-limiting examples of suitable polyhydric alcohols include: glycerol (also known in the art as glycerin), glycol, sugar, sugar alcohol, and combinations thereof. Non-limiting examples of glycols of use include: ethylene glycol, propylene glycol, dipropylene glycol, butylene glycol, hexane triol, and the like, oligomers thereof, and combinations thereof. Non-limiting examples of sugars of use include: glucose, sucrose, fructose, raffinose, maltodextrose, galactose, xylose, maltose, lactose, mannose, erythrose, pentaerythritol, and mixtures thereof. Non-limiting examples of sugar alcohols of use include: erythritol, xylitol, malitol, mannitol, sorbitol, and mixtures thereof. In specific embodiments of the present invention, the polyhydric alcohol comprises glycerol, mannitol, sorbitol, and combinations thereof.

Typically, the polyhydric alcohol can be present in reactive mixtures of the present invention in an amount of from about 5% to about 80%, from about 10% to about 75%, from about 25% to about 70%, or from about 35% to about 65%.

### Organic Polyacid and Anhydrides

The reactive mixture used in forming the reactive pellets includes organic polyacids and anhydrides. The organic polyacid means an organic acid having two or more acid functionalities and can include, but is not limited to, diacids, triacids (having at least three acid groups), other acids with four or more acid functionalities, acid polymers or copolymers, or mixtures thereof. Such acids include, but are not limited to adipic acid, sebatic acid, citric acid, oxalic acid, malonic acid, succinic acid, glutaric acid, maleic acid, fumaric acid, phthalic acid, isophthalic acid, terphthalic acid, and mixtures of two or more thereof. Anhydrides of such acids may also be employed and within the context of the present specification, reference to organic polyacid includes such anhydrides. Monoacids such as lauric acid, stearic acid, myristic acid, palmitic acid, oleic acid, linoleic acid, sebacic acid, acrylic acid, methacrylic acid, itaconic acid, and glycidyl methacrylate may optionally be included in addition to polyacids at any stage. For example, monoacids may be added as processing aids or to modify properties of the final product, e.g. flexibility, strength, etc.

For the present invention many different types of organic polyacids and anhydrides can be used including adipic acid, citric acid, maleic acid, maleic anhydride, polyacrylic acid, phthalic anhydride, and the like, as well as their mixtures. Monobasic acids, especially fatty acids like stearic acid, lauric acid, oleic acid, and linoleic acid, can also be incorporated into the reaction mixture. Other functional compounds with reactive acid or alcohol functionality, such as oligomeric silicone or polyethylene glycol, may also be incorporated.

Typically, the organic polyacid or anhydride is employed in the reactive mixtures of the present invention in an amount of from about 5% to about 80%, from about 10% to about 75%, from about 25% to about 70%, or from about 35% to about 65%.

### Triglyceride

Any suitable triglycerides, which are also known in the art as triacylglycerols, may also be included in the reactive mixture. Non-limiting examples of triglycerides of use include: tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin and combinations thereof.

Suitable triglycerides may be added to the present reactive compositions in neat form. Additionally, or alternatively, oils and/or processed oils containing suitable triglycerides may be added to the reactive compositions. Non-limiting examples of oils include coconut oil, corn germ oil, olive oil, palm seed oil, cottonseed oil, palm oil, rapeseed oil, sunflower oil, whale oil, soybean oil, peanut oil, linseed oil, tall oil, and combinations thereof.

Typically, triglycerides are employed in the reactive mixture in an amount up to about 75%, or from about 2% to about 50%, or from about 5% to about 25%.

In some embodiments, combinations of acid and triglyceride are employed in the reactive mixture. In such embodiments, the total amounts of acid and triglyceride is from about 20% to about 80%, from about 30% to about 70%, or from about 40% to about 60%. Additionally, or alternatively, the molar ratio of the alcohol functional groups to the total of ester and acid functional groups is at least about 1:1, or at least about 4:1. In some embodiments, the molar ratio is from about 1:1 to about 200:1, or from about 1:1 to about 50:1.

The reactive mixture of the present invention may also include monobasic acid, and appropriate amounts of monoglyceride, or diglyceride as alternatives to triglyceride.

### Additional Components

The reactive mixtures used in forming the reactive pellets may further include one or more additional components as desired for the processing and/or end use of the composition. Additional components may be present in any suitable amount. In some embodiments, additional components may be present in an amount of from about 0.01% to about 35% or from about 2% to about 20% by weight of the reactive mixture. Non-limiting examples of additional components include, but are not limited to, additional polymers, processing aids and the like.

Non-limiting examples of additional polymers of use include: polyhydroxyalkanoates, polyethylene, polypropylene, polyethylene terephthalate, maleated polyethylene, maleated polypropylene, polylactic acid, modified polypropylene, nylon, caprolactone, and combinations thereof. Additional polymers also include polyvinyl alcohol and polyhydric alcohols having molecular weights of greater than 2000 g/mol.

In embodiments in which properties including, but not limited to, biodegradability and/or flushability are desired, additional suitable biodegradable polymers and combinations thereof are of use. In some embodiments, polyesters containing aliphatic components are suitable biodegradable thermoplastic polymers. In some embodiments, among the polyesters, ester polycondensates containing aliphatic constituents and poly(hydroxycarboxylic acid) are preferred. The ester polycondensates include, but are not limited to: diacids/diol aliphatic polyesters such as polybutylene succinate, and polybutylene succinate co-adipate; aliphatic/aromatic polyesters such as terpolymers made of butylenes diol, adipic acid, and terephthalic acid. The poly(hydroxycarboxylic acids) include, but are not limited to: lactic acid based homopolymers and copolymers; polyhydroxybutyrate; and other polyhydroxyalkanoate homopolymers and copolymers. In some embodiments, a homopolymer or copolymer of poly lactic acid is preferred. Modified polylactic acid and different stereo configurations thereof may also be used. Suitable polylactic acids typically have a molecular weight range of from about 4,000 g/mol to about 400,000 g/mol. Examples of suitable commercially available poly lactic acids include NATUREWORKS™ from Cargill Dow and LACEA™ from Mitsui Chemical. An example of a suitable commercially available diacid/diol aliphatic polyester is the polybutylene succinate/adipate copolymers sold as BIONOLLE™ 1000 and BIONOLLE™ 3000 from the Showa Highpolmer Company, Ltd. Located in Tokyo, Japan. An example of a suitable commercially available aliphatic/aromatic copolyester is the poly(tetramethylene adipate-co-terephthalate) sold as EASTAR BIO™ Copolyester from Eastman Chemical or ECOFLEX™ from BASF. In some embodiments, the biodegradable polymer or combination of polymers may comprise polyvinyl alcohol.

The aforementioned biodegradable polymers and combinations thereof may be present in an amount of from about 0.1% to about 70%, from about 1% to about 50%, or from about 2% to about 25%, by weight of the reactive mixture.

Processing aids are generally present in the reactive mixture in amounts of from about 0.1% to about 3% or from about 0.2% to about 2% by weight of the reactive mixture. Non-limiting examples of processing aids include: lubricants, anti-tack, polymers, surfactants, oils, slip agents, and combinations thereof. Non-limiting examples of specific processing aids include: Magnesium stearate; fatty acid amides; metal salts of fatty acids; wax acid esters and their soaps; montan wax acids, esters and their soaps; polyolefin waxes; non polar polyolefin waxes; natural and synthetic paraffin waxes; fluoro polymers; and silicon. Commercial examples of such compounds include, but are not limited to: Crodamide™ (Croda, North Humberside, UK), Atmer™ (Uniqema, Everberg, Belgium,) and Epostan™ (Nippon Shokobai, Tokyo, JP).

Other additives can be present in the reactive mixture to impart additional physical properties to the final product or material formed therefrom. Such additives include compounds having functional groups such as acid groups, alcohol groups and combinations thereof. Such compounds include oligomeric silicone, polyethylene glycol and combinations thereof

### Fillers

The fillers mixed with the reactive mixture providing the reactive composition which is formed into reactive pellets comprise solid particulates having an equivalent diameter of less than 300 microns, less than 100 microns or less than 50 microns. Non-limiting examples of fillers present in the reactive composition of the present invention include: talc, clay, pulp, wood, flour, walnut shells, cellulose, cotton, jute, raffia, rice chaff, animal bristles, chitin, TiO₂, thermoplastic starch, raw starch, granular starch, diatomaceous earth, nanoparticles, carbon fibers, kenaf, silica, inorganic glass, inorganic salts, pulverized plasticizer, pulverized rubber, polymeric resins and combinations thereof. Further additives including inorganic fillers such as the oxides of magnesium, aluminum, silicon, and titanium may also be added as inexpensive fillers or processing aides. Other inorganic materials include hydrous magnesium silicate, titanium dioxide, calcium carbonate, boron nitride, limestone, mica glass quartz, and ceramics. Additionally, inorganic salts, including alkali metal salts, alkaline earth metal salts, phosphate salts, may be used as processing aides. Another material that can be added is a chemical composition formulated to further accelerate the environmental degradation process such as cobalt stearate, citric acid, calcium oxide, and other chemical compositions found in U.S. Pat. No. 5,854,304 to Garcia et al.

The aforementioned fillers and combinations thereof may be present in the reactive composition forming the reactive pellets in an amount of from about 25% to about 80%, from about 30% to about 70%, or from about 50% to about 65%, by weight of the reactive composition.

### Ester Condensation Reaction

As previously described herein, alkyd resins are made from the condensation reaction of a reactive mixture comprising monomers, such as polyhydric alcohol and a polyfunctional organic polyacid, or from an oligomer which is prepolymer made by reacting the monomer mixture to a precrosslinking stage where condensation reaction has already at least partially, but not completely taken place between the polyhydric alcohol and the acid. During the condensation reaction, if the temperature of the reactive mixture is sufficiently high and for a sufficient time to drive a reaction between the polyhydric alcohol and the acid, the composition which is formed will convert to a water stable alkyd resin composition. For example, the reactive mixture can be melt processed in an extruder provided with vents or other modifications which facilitate water removal and the conversion to a water stable composition. In such an embodiment, it is therefore advantageous to melt extrude the composition to a form which is suitable for end use, for example, as films, sheets, and molded articles and combinations thereof.

On the other hand, if the temperature or conditions at which the melt processing of the reactive mixture is conducted is sufficiently low and/or for an insufficient time to drive reaction between the polyhydric alcohol and the acid, the resulting extrudate comprises a reactive mixture, which may be further processed, if desired, and which is convertible to water stable compositions by further heating. The reactive mixture can therefore be provided in this embodiment in a form which facilitates handling, further processing, or the like. For example, the reactive mixture can be combined with filler forming a reactive composition in accordance with the present invention that can be extruded into a solid form. In a specific embodiment, the reactive composition extrudate is formed into reactive pellets which are suitable for melt processing. In this embodiment, the further melt processing of the reactive pellets to form films, sheets, coatings, and molded articles, or other desired product forms, may be conducted under sufficient conditions of temperature and time to effect the conversion of the reactive composition to a water stable composition or product. Alternatively, if the melt processing is not conducted under sufficient conditions of temperature and time to effect the conversion of the reactive composition to a water stable composition, the resulting reactive composition can be subsequently heated and converted to a water stable product.

### Reactive Pellet Formation

For the present invention, the reactive monomer mixture or prepolymer is mixed with a substantial amount of particulate fillers previously described, such that the rheological consistency of the mixture is suited for producing melt processable reactive pellets. The monomer mixture or prepolymer can be heated to make it sufficiently fluid for easy mixing with particulate fillers. For instance, during mixing the temperature of the reactive mixture ranges from about 80° C. to about 130° C. and the viscosity of the reactant mixture can be less than about 1000 poise, less than about 500 poise, less than about 200 poise, and less than about 100 poise. A sufficient amount of particulate fillers are added to achieve the consistency of pliable dough or molten plastic which can be extruded into strands and cut into small pellets. Upon cooling, the pellets become sufficiently hard and non sticky maintaining a granular form without conglomerating to facilitate handling. The resulting reactive melt-processable composite pellets can be fed to melt processing equipment, such as an extruder coupled with an injection mold, in a manner similar to the processing of conventional thermoplastic resins.

During the formation of the reactive mixture, it is desirable that the ester condensation reaction resulting in crosslinking is below the gel point for the alkyd condensation reaction. The gel point is defined as the state at which enough polymer chains formed by the products of the reactants are bonded together such that at least one very large molecule is coextensive with the polymer phase and flow is no longer possible such that the material behaves more like a solid. It is desirable for the reactant mixture to be below the gel point before final processing so as to retain sufficient flow behavior to enable shaping of the mixture into articles.

Up until to the gel point, it may be advantageous for the condensation reaction of the reactive mixture to proceed to a point where prepolymers such as oligomers or even larger molecules are formed, yet the mixture retains the ability to flow and be shaped into useful articles. In some embodiments of the current invention, it may be advantageous to enable the ester condensation reaction of the reactive mixture to proceed to an extent approaching the gel point so that maximum water is removed from the reactive mixture while retaining the ability of the reactive mixture to flow prior to mixing with filler and forming the reactive pellets. Maximizing the removal of the water from the reactive mixture prior to forming the pellets can minimize the remaining ester condensation reaction and corresponding water removal required in the final processing steps when the reactive pellets are melt processed and formed into articles.

The reactive pellets according to the present invention can be formed by melt mixing and/or extruding a reactive composition including a reactive mixture comprising reactive monomer mixture or prepolymer and filler using conventional mixing and/or extrusion techniques. The components are typically mixed using conventional compounding techniques. The objective of the compounding step is to produce a visually homogeneous melt composition.

A suitable mixing device is a multiple mixing zone twin screw extruder with multiple injection points. The multiple injection points can be used to add the reactive mixture and filler. A twin screw batch mixer or a single screw extrusion system can also be used. As long as sufficient mixing and heating occurs, the particular equipment used is not critical. An alternative method for compounding the materials comprises adding reactive mixtures to an extrusion system where they are mixed in progressively increasing temperatures. For example, a twin screw extruder with six heating zones may be employed. However, it may not be necessary to extrude a melt mixture in order to form the pellets, and, in general, any method known in the art or suitable for the purposes hereof can be used to combine the ingredients of the components to form the reactive compositions and corresponding reactive pellets of the present invention. Typically, such techniques will include heat and mixing, and optionally pressure. The particular order or mixing, temperatures, mixing speeds or time, and equipment can be varied, as will be understood by those skilled in the art.

### Melt Processing Pellets

When the reactive pellets formed from the reactive compositions are melt processed and made into articles, the crosslinking reaction can be completed either during the melt processing of the reactive pellets or by an additional post curing step following the melt processing. In order to produce fully crosslinked articles from melt processing the reactive pellets, the ester condensation reaction of the reactive mixture is induced, and/or driven towards completion through the application of heat during melt processing. Water produced as a reaction byproduct is effectively removed to promote the reaction. The reaction mixture temperature may be between about 100° C. and about 300° C., between about 120° C. and about 280° C., or between about 150° C. and about 260° C. to drive the crosslinking reaction to completion during melt processing. In some embodiments of the present invention, a catalyst may be used to initiate and/or accelerate the ester condensation and/or transesterification reactions. Any suitable catalyst is of use. Non-limiting examples of useful catalysts include Lewis acids. Non-limiting examples of catalysts include para-toluenesulfonic acid, methanesulfonic acid, and linear alkylbenzenesulfonic acid.

Completing the crosslinking reaction via post curing can be accomplished in a conventional convective or radiant oven or microwave oven, as well as other means to heat the product during the post curing step to complete the ester condensation reaction and corresponding final removal of water from the article.

### Articles

As used herein, “article” is meant to encompass articles made solely from, or having at least one portion made from melt processable reactive pellets according to the present invention.

Articles include, but are not limited to extruded articles such as: films, sheets, laminates, coatings, and foams; molded articles; and combinations thereof. Personal hygiene articles and absorbent articles may be articles or comprise articles made from reactive compositions of the present invention.

### Extruded Articles

### Films

In some embodiments of the present invention, the article is a film. As used herein, “film” means a thin continuous material or substrate having a high length to thickness ratio and a high width to thickness ratio, “high” meaning a ratio of over about 10:1. While there is no requirement for a precise upper limit of thickness, an upper limit would be about 0.254 mm, about 0.01 mm, or about 0.005 mm.

The films of the present invention can be employed in a variety of disposable products including, but not limited to, disposable personal hygiene articles (e.g., diapers, catamenials and the like), wrapping (e.g., food wraps, consumer product wraps, pallet and/or crate wraps, and the like), or bags (grocery bags, food storage bags, sandwich bags, resealable bags, garbage bags, and the like). The protective value of the present films, much like other films, may depend on its being continuous, i.e., without holes or cracks, such that it may serve as an efficient barrier to molecules such as atmospheric water vapor, and/or oxygen. In some embodiments of the present invention, the films are liquid impervious and suitable for use in absorbent disposable sanitary items including, but not limited to, disposable diapers, feminine hygiene pads and the like.

Films of the present invention may have a number of physical characteristics, such as biodegradability and compostability, for example. Films that perform well as compostable backsheets in personal hygiene articles including, but not limited to, diapers and feminine hygiene pads, may have characteristics such as those described in U.S. Pat. No. 5,498,692.

The films of the present invention may be made using any suitable process that is used for producing single or multilayer films. Non-limiting examples of methods of use include cast film blowing, cast film extrusion and blown film extrusion. These methods as well as other suitable methods are described in U.S. Pat. No. 5,498,692.

In some embodiments, strands, pellets, or powders made from the presently disclosed reactive compositions, as well as combinations thereof, are dry blended and melt mixed in a film extruder. In embodiments in which insufficient mixing occurs in the film extruder, the strands, pellets, powders and combinations thereof, can be first dry blended and then melt mixed in a pre-compounding extruder followed by re-pelletization prior to film extrusion.

### Foams

In another embodiment of the present invention, the article is foam. As used herein, “foam” refers to the reactive compositions of the present invention wherein the apparent density has been substantially decreased by the presence of numerous cells distributed throughout its bulk (see ASTM D 883-62T, American Society for Testing and Materials, Philadelphia, Pa., (1962)). Such two-phase gas/solid systems in which the solid is continuous and composed of a synthetic polymer or rubber include cellular polymers (or copolymers), expanded plastics and foamed plastics (ENCYCLOPEDIA OF CHEMICAL TECHNOLOGY, Vol. 11, John Wiley & Sons, New York (1980)).

The gas phase may be distributed into pockets or voids called “cells” which are classified into two types, open and closed. Open-celled materials are foams the cells of which are inter-connected such that gases may pass freely through the cells. Closed-cell materials have cells that are discrete and isolated from each other.

Foams are further categorized into flexible and rigid foams. This classification is based on a particular ASTM test procedure (see ASTM D, Vol. 37, pp. 1566-1578, American Society of Testing and Materials, Philadelphia, Pa., (1978)). Flexible foam is foam which does not rupture when a 20×2.5×2.5 cm piece is wrapped around a 2.5 cm mandrel at a uniform rate of 1 lap/5 s at 15-25° C. Foams that do rupture under this test are referred to as rigid foams.

Foams according to the present invention may find any suitable use including, but not limited to, packaging, comfort cushioning, insulation, structural components and the like. In some areas of packaging, a foamed material having increased biodegradability and/or compostability would offer superior benefits to packaging that is currently used, such as polystyrene, paper and starch foams for example. In hot food containers, polystyrene offers significantly higher thermal insulation over the only currently degradable alternative, paper wraps. Foamed articles comprising the reactive compositions of the present invention have the thermal insulating properties of polystyrene, yet are biodegradable and/or compostable. These materials are ideal for hot food take-out and cold food packaging.

Foamed polystyrene chips are used as cushioned packing materials for consumer and industrial goods. Many of these chips are disposed of in landfills. Foamed chips comprising a reactive composition of the present invention can perform like polystyrene yet have increased biodegradability and/or compostability. Moreover, foamed chips according to the present invention may be water stable.

The foams of the present invention may be made using any suitable process. Non-limiting examples of methods are described in U.S. Pat. No. 5,498,692.

### Molded Articles

In another embodiment of the present invention, the article is a molded article. As used herein, “molded articles” refer to objects that are formed from the reactive composition. The melt processable reactive pellets formed from the reactive composition of the present invention may be melt processed and subsequently, for example, injected, compressed, or blown by means of a gas into shape defined by a female mold. These objects can be solid objects like toys, or hollow like bottles and containers. Methods of making molded articles are described in further detail in U.S. Pat. No. 5,498,692.

### Disposable Personal Care Products

The present invention further relates to disposable personal care products comprising reactive compositions of the present invention. In some embodiments, disposable personal care absorbent articles comprise a liquid pervious topsheet, a liquid impervious backsheet comprising a film of the present invention, and an absorbent core positioned between the topsheet and backsheet. In some embodiments, the personal care absorbent articles are compostable. Non-limiting examples of such absorbent articles include infant diapers, adult incontinent briefs and pads, and feminine hygiene pads and liners.

Additional personal care products comprising a reactive composition of the present invention include, but are not limited to: personal cleansing wipes; disposable health care products such as bandages, wound dressings, wound cleansing pads, surgical gowns, surgical covers, surgical pads; other institutional and health care disposables such as gowns, wipes, pads, bedding items such as sheets and pillowcases, foam mattress pads.

Importantly, the absorbent articles according to the present invention may be biodegradable and/or compostable to a greater extent than conventional absorbent articles which employ materials such as a polyolefin (e.g., a polyethylene backsheet).

### EXAMPLES

### Example 1

### Preparation of Reactive Monomer Mixtures

1,000 g of glycerol (Superol Glycerin, Procter & Gamble, Cincinnati) is heated to about 60° C. to reduce excess viscosity. 2.5 g of linear alkylbenzenesulfonic acid (HLAS, Procter & Gamble, Cincinnati) is added as a catalyst, and 1,000 g of maleic anhydride (Aldrich, St. Louis) is gradually mixed with the glycerol to form a clear solution mixture. This procedure is repeated by replacing the maleic anhydride with citric acid, adipic acid, or succinic acid (Aldrich, St. Louis) to make different monomer mixtures.

### Example 2

### Preparation of Reactive Prepolymers

1,000 g of the mixture of glycerol, maleic anhydride, and HLAS in Example 1 is heated to 140° C. to carry out the condensation reaction between maleic anhydride and glycerol to produce oligomeric reactive prepolymer. The reaction is stopped and cooled below 100° C. within 40 minutes to keep the mixture from gelling. Other reactive prepolymers are also made in a similar manner by using the other reactive monomer mixtures of Example 1.

### Example 3

### Preparation of Pellets with Reactive Prepolymers

450 g of the warm reactive glycerol maleate prepolymer Example 2 is mixed with 550 g of kaolin clay (Unimin Corporation, Snobrite) using a laboratory mixer to produce a soft dough. The dough is further mixed by passing it through an electric meat grinder (Kitchen Aid, St. Joseph, Mich.). The dough mixture is fed to a co-rotating extruder (Berstorff Ultraglide), with the zone temperature setting of 106° F., 160° F., 200° F., 271° F., 300° F., 325° F., and 350° F., which is operated with the screw speed at 150 rpm. A strand of the hot extrudate is cooled on an air table and then pelletized with a Berlyn pelletizer (Worcester, Mass.). A similar procedure is used for making pellets with other reactive prepolymers of Example 2.

### Example 4

### Preparation of Pellets with Monomer Mixtures

400 g of 140° C. mixture of glycerol and maleic anhydride of Example 1 is mixed with 600 g of kaolin clay (Unimin Corporation, Snobrite) using a laboratory mixer to produce a soft dough. The dough is further mixed by passing it through a meat grinder (Kitchen Aid, St. Joseph, Mich.). The dough mixture is fed to a co-rotating extruder (Berstorff Ultraglide), with the zone temperature setting of 106° F., 160° F., 200° F., 271° F., 300° F., 325° F., and 350° F., which is operated with the screw speed at 150 rpm. A strand of the hot extrudate is cooled on an air table and then pelletized with a Berlyn pelletizer (Worcester, Mass.). A similar procedure is used for making pellets with other monomer mixtures of Example 1.

### Example 5

### Preparation of Molded Articles

The melt processable reactive pellets of Example 3 are fed to an extruder (Berstorff Ultraglide) coupled with an injection molder (Arburg GmbH), and molded articles are produced in a manner similar to ordinary plastic articles. Some of the molded articles are baked in an oven at 90° C. for 16 hours to further complete the curing of the reactive component.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Reactive pellets comprising at least one filler and a reactive mixture selected from the group consisting of:
(a) a monomer mixture comprising at least one polyhydric alcohol and reactant selected from the group consisting of: at least one organic polyacid; at least one organic anhydride; and combinations thereof;
(b) prepolymer formed from the monomer mixture according to (a);
(c) combinations of the monomer mixture in (a) and the prepolymer in (b); and
(d) combinations of the prepolymer in (b) and reactants selected from the group consisting of: polyhydric alcohol; organic polyacid; organic anhydride; and combinations thereof;
wherein the reactive pellets are melt processable into thermoset alkyd resin.

2. The reactive pellets according to claim 1, wherein the polyhydric alcohol is selected from the group consisting of glycerol, glycol and combinations thereof.

3. The reactive pellets according to claim 1, wherein the organic polyacid is selected from the group consisting of adipic acid, citric acid, maleic acid, succinic acid, polyacrylic acid and combinations thereof.

4. The reactive pellets according to claim 1, wherein the anhydride is selected from the group consisting of succinic anhydride, maleic anhydride, phthalic anhydride and combinations thereof.

5. The reactive pellets according to claim 1, wherein the reactive mixture further comprises monobasic acid, monoglyceride, diglyceride, or triglyceride.

6. The reactive pellets according to claim 1, wherein the reactive mixture further comprises compounds having functional groups selected from the group consisting of acid groups, alcohol groups and combinations thereof, and further wherein the compounds are selected from the group consisting of oligomeric silicone, polyethylene glycol and combinations thereof.

7. The reactive pellets according to claim 1, wherein the at least one filler is selected from the group consisting of: talc, clay, pulp, TiO₂, thermoplastic starch, raw starch, wood flour, diatomaceous earth, carbon black, silica, inorganic glass, inorganic salts, pulverized plasticizer, pulverized rubber and combinations thereof.

8. A process for making melt processable reactive pellets comprising the steps of:
a) providing a reactive mixture selected from the group consisting of:
1) a monomer mixture comprising at least one polyhydric alcohol and reactant selected from the group consisting of: at least one organic polyacid; at least one organic anhydride; and combinations thereof;
2) prepolymer formed from the monomer mixture according to (1);
3) combinations of the monomer mixture in (1) and the prepolymer in (2); and
4) combinations of the prepolymer in (2) and reactants selected from the group consisting of: polyhydric alcohol; organic polyacid; organic anhydride; and combinations thereof;
b) providing a filler;
c) combining the reactive mixture and the filler to form a homogeneous mixture;
d) extruding the homogeneous mixture to form strands; and
e) cutting the strands into pellets;
wherein said pellets are melt processable into thermoset alkyd resin.

9. The process according to claim 8, wherein the polyhydric alcohol is selected from the group consisting of glycerol, glycol and combinations thereof.

10. The process according to claim 8, wherein the organic polyacid is selected from the group consisting of adipic acid, citric acid, maleic acid, succinic acid, polyacrylic acid and combinations thereof.

11. The process according to claim 8, wherein the anhydride is selected from the group consisting of succinic anhydride, maleic anhydride, phthalic anhydride and combinations thereof.

12. The process according to claim 8, wherein the reactive mixture formed further comprises monobasic acid, monoglyceride, diglyceride, or triglyceride.

13. The process according to claim 8, wherein the reactive mixture formed further comprises compounds having functional groups selected from the group consisting of acid groups, alcohol groups and combinations thereof, and further wherein the compounds are selected from the group consisting of oligomeric silicone, polyethylene glycol and combinations thereof.

14. The process according to claim 8, wherein the filler is selected from the group consisting of: talc, clay, pulp, TiO₂, thermoplastic starch, raw starch, wood flour, diatomaceous earth, carbon black, silica, inorganic glass, inorganic salts, pulverized plasticizer, pulverized rubber and combinations thereof.

15. Articles made from melt processable reactive pellets comprising at least one filler and a reactive mixture selected from the group consisting of:
(a) a monomer mixture comprising at least one polyhydric alcohol and reactant selected from the group consisting of: at least one organic polyacid; at least one organic anhydride; and combinations thereof;
(b) prepolymer formed from the monomer mixture according to (a);
(c) combinations of the monomer mixture in (a) and the prepolymer in (b); and combinations of the prepolymer in (b) and reactants selected from the group consisting of: polyhydric alcohol; organic polyacid; organic anhydride; and combinations thereof;
wherein said pellets are melt processed into thermoset alkyd resin to form said articles.

16. Articles according to claim 15 selected from the group consisting of molded objects, sheets, films, fibers, foams and combinations thereof.

17. Articles according to claim 15, wherein the polyhydric alcohol is selected from the group consisting of glycerol, glycol and combinations thereof.

18. Articles according to claim 15, wherein the organic polyacid is selected from the group consisting of adipic acid, citric acid, maleic acid, succinic acid, polyacrylic acid and combinations thereof.

19. Articles according to claim 15, wherein the anhydride is selected from the group consisting of succinic anhydride, maleic anhydride, phthalic anhydride and combinations thereof.

20. Articles according to claim 15, wherein the at least one filler is selected from the group consisting of: talc, clay, pulp, TiO₂, thermoplastic starch, raw starch, wood flour, diatomaceous earth, carbon black, silica, inorganic glass, inorganic salts, pulverized plasticizer, pulverized rubber and combinations thereof.
